(19) United States
(12) Patent Application Publication
(10) Pub. No.: US 2026/0222990 A1
(43) Pub. Date: Jul. 30, 2026

(54) INFORMATION PROCESSING APPARATUS, METHOD, AND STORAGE MEDIUM STORING PROGRAM

(71) Applicant: CANON KABUSHIKI KAISHA, Tokyo (JP)

(72) Inventor: KOJI INAGAKI, Tokyo (JP)

(21) Appl. No.: 19/449,663

(22) Filed: Jan. 15, 2026

(30) Foreign Application Priority Data
Jan. 29, 2025 (JP) 2025-013209

(51) Int. Cl. H04W 52/02

(52) U.S. Cl. CPC H04W 52/0225

(57) ABSTRACT

An information processing apparatus having a first power state and a second power state in which power consumption is reduced compared to the first power state, includes: an obtaining unit that obtains, via a communication interface, from an external device to which the information processing apparatus is connected, predetermined information including information indicating a channel used by the external device, at a regular interval; and a control unit that, in the first power state, controls the obtaining unit to obtain the predetermined information from the external device at a first interval, and, in the second power state, in a case where the predetermined information is to be obtained from the external device, perform control to supply power to the communication interface and control the obtaining unit to obtain the predetermined information from the external device at a second interval longer than the first interval.

### BACKGROUND

### Field of the Technology

The present disclosure relates to an information processing apparatus, a method, and a storage medium storing a program.

### Description of the Related Art

An information processing apparatus such as a printer, a digital still camera, or the like has modes referred to as a normal mode (referred to below as a normal state) and a power saving mode (referred to below as a power saving state) in which power consumption is reduced compared to the normal state. In the power saving state, for example, power consumption is reduced by stopping the supply of power or a clock signal to hardware not used in the power saving state (Japanese Patent Laid-Open No. 2021-136464).

### SUMMARY

The present disclosure provides an information processing apparatus, a method, and a program that suppresses a reduction in a power saving effect.

The present disclosure in one aspect provides an information processing apparatus having a first power state and a second power state in which power consumption is reduced compared to the first power state, comprising: at least one memory and at least one processor which function as: an obtaining unit configured to obtain, via a communication interface, from an external device to which the information processing apparatus is connected, predetermined information including information indicating a channel used by the external device, at a regular interval; and a control unit configured to, in the first power state, control the obtaining unit to obtain the predetermined information from the external device at a first interval, and, in the second power state, in a case where the predetermined information is to be obtained from the external device, perform control to supply power to the communication interface and control the obtaining unit to obtain the predetermined information from the external device at a second interval longer than the first interval.

According to the present disclosure, a reduction in the power saving effect can be suppressed.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a system configuration.

FIG. 2 is a diagram illustrating an external appearance of an MFP.

FIG. 3 is a diagram illustrating a configuration of the MFP.

FIGS. 4A to 4D are diagrams illustrating user interface screens.

FIG. 5 is a flowchart illustrating processing in the MFP.

FIG. 6 is a flowchart illustrating processing in the MFP.

FIG. 7 is a flowchart illustrating processing in the MFP.

FIG. 8 is a diagram illustrating a user interface screen.

FIG. 9 is a flowchart illustrating processing in the MFP.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

An information processing apparatus receives wireless information from an external device via wireless communication at regular intervals in order to monitor the wireless communication state. In a case where the information processing apparatus receives wireless information in a power saving state, power needs to be supplied to the hardware used in wireless communication, and thus power consumption in the power saving state is increased.

According to the present disclosure, a reduction in the power saving effect can be suppressed.

### First Embodiment

### System Configuration

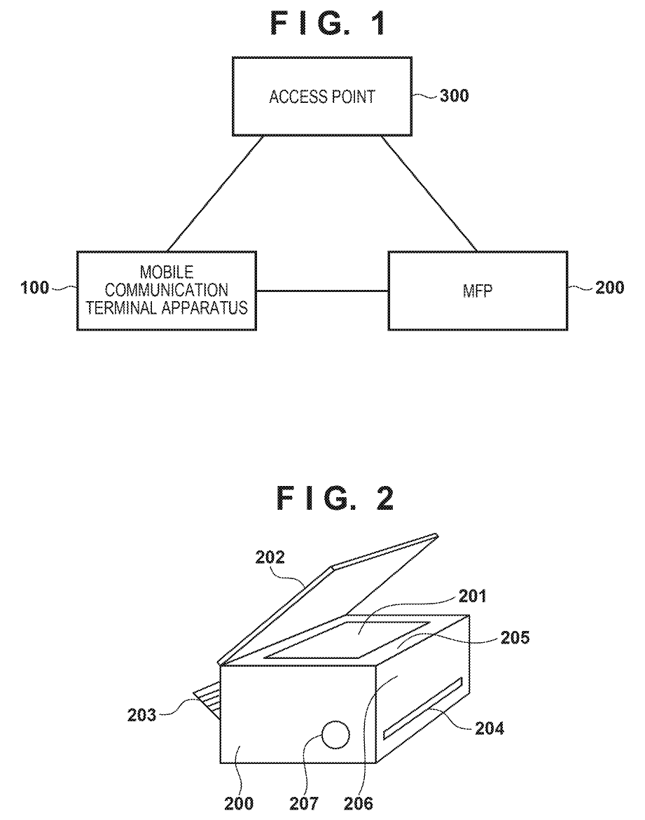

FIG. 1 is a diagram illustrating an example configuration of a system according to the present embodiment. The present system, in this example, is a wireless communication system in which a plurality of communication apparatuses can wirelessly communicate with one another. In the example of FIG. 1, the communication apparatuses include a mobile communication terminal apparatus (terminal apparatus) 100, an MFP 200, and an access point (AP) 300. Specifically, the AP 300 is a wireless LAN router, for example. The terminal apparatus 100 is an apparatus with a wireless communication function such as wireless LAN, Bluetooth (registered trademark), or the like. Note that hereinafter, wireless LAN may be referred to as WLAN, and Bluetooth may be referred to as BT. The terminal apparatus 100 may be a personal digital assistant (PDA) or similar personal information terminal, a mobile phone (smartphone), a digital camera, a personal computer, or the like. In the present embodiment, connection between the terminal apparatus 100 and the AP 300 and connection between the MFP 200 and the AP 300 correspond to connection via a communication method based on an IEEE 802.11 series standard. Specifically, a communication method based on an IEEE 802.11 series standard is Wireless Fidelity (Wi-Fi) (registered trademark).

The MFP 200 is a printing apparatus or an image forming apparatus with a print function and may also have a read function (scanner), a fax function, and a phone function. Also, the MFP 200 according to the present embodiment has a communication function enabling wireless communication with the terminal apparatus 100. Also, in the present embodiment described herein, the MFP 200 is used as an example, but no such limitation is intended. For example, instead of the MFP 200, a scanner apparatus, a projector, a mobile terminal, a smartphone, a notebook PC, a tablet terminal, a PDA, a digital camera, a music playback device, a television, a smart speaker, or the like with a communication function may be used. Note that MFP is an acronym for multifunction peripheral.

The AP 300 is provided separately from (external to) the terminal apparatus 100 and the MFP 200 and operates as a WLAN base station apparatus. A communication apparatus with a WLAN communication function can perform communication in WLAN infrastructure mode via the AP 300. Note that hereinafter, infrastructure mode may be referred to as “infrastructure connection mode”. The AP 300 performs wireless communication with a communication apparatus permitted (authenticated) to connect to it, and relays wireless communication between that communication apparatus and other communication apparatuses. Also, the AP 300 may be connected to a wired communication network, for example, and relay communication between a communication apparatus connected to this wired communication network and other communication apparatuses wirelessly connected to the AP 300.

The terminal apparatus 100 and the MFP 200 use their respective WLAN communication function and perform wireless communication in an infrastructure connection mode via the AP 300 and in a peer-to-peer mode without the AP 300. Note that hereinafter, peer-to-peer may be referred to as “P2P”. P2P connection modes include Wi-Fi Direct (registered trademark), SoftAP mode, and the like. Note that hereinafter, Wi-Fi Direct (registered trademark) may be referred to as WFD.

FIG. 2 is a diagram illustrating an external appearance configuration example of the MFP 200. The MFP 200 includes a platen 201, a document cover 202, a printing paper insertion opening 203, a printing paper discharge opening 204, an operation display unit 205, and a power operation unit 207. The platen 201 is a platform for placing documents to be read. The document cover 202 is a cover used to press against a document placed on the platen 201 and prevent light from a light source illuminating the document escaping out during reading. The printing paper insertion opening 203 is an insertion opening where various sizes of sheets can be set. The printing paper discharge opening 204 is a discharge opening where sheets are discharged after printing. The sheets set in the printing paper insertion opening 203 are conveyed one sheet at a time to a printing unit and are discharged from the printing paper discharge opening 204 after printing has been performed by the printing unit. The operation display unit 205 includes character input keys, a cursor key, an enter key, a cancel key, and/or similar keys; LEDs; an LCD; and the like and receives operations by the user relating to the activation of various types of functions and various types of settings. Also, the operation display unit 205 may include a touch panel display. The MFP 200 has a wireless communication function using WLAN or BT and includes a wireless communication antenna 206 for such wireless communication. The MFP 200 can perform wireless communication via WLAN or BT in a frequency range of the 2.4 GHz band or the 5 GHz band. Also, the power operation unit 207 is a switch and can display and turn off a display on the operation display unit 205 in response to the user pressing the switch.

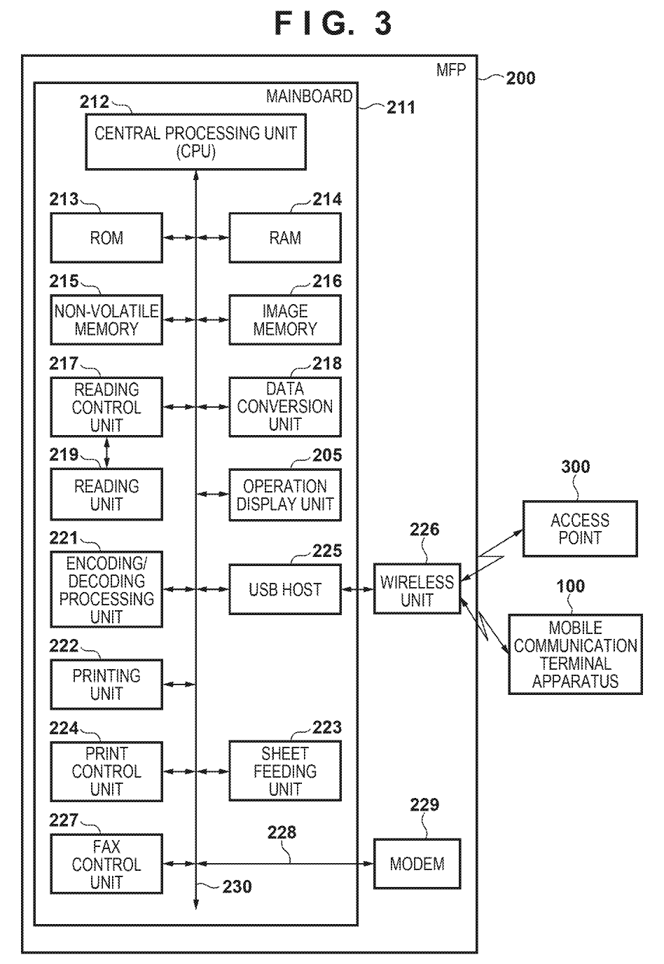

FIG. 3 is a diagram illustrating a configuration example of the MFP 200. The MFP 200 includes a mainboard 211 for performing main control of the apparatus itself and a wireless unit 226, which is a single communication module for performing WLAN communication and BT communication using at least one shared antenna. Also, the MFP 200 includes a modem 229 for performing wired communication, for example. The mainboard 211 includes, for example, a CPU 212, a ROM 213, a RAM 214, a non-volatile memory 215, an image memory 216, a reading control unit 217, a data conversion unit 218, a reading unit 219, and an encoding/decoding processing unit 221. Also, the mainboard 211 includes, for example, a printing unit 222, a sheet feeding unit 223, a print control unit 224, the operation display unit 205, a USB host 225, a FAX control unit 227, and the power operation unit 207. These functional units in the mainboard 211 are connected to one another via a system bus 230 managed by the CPU 212. Also, the mainboard 211 and the wireless unit 226 are connected via the Universal Serial Bus (USB) host 225, and USB communication is performed between the USB host 225 and the wireless unit 226. In the present embodiment, communication between an external apparatus such as the AP 300, the terminal apparatus 100, and the like and the MFP 200 is performed via USB communication, which is an internal interface. Thus, in other words, the USB host 225 and the wireless unit 226 may be considered to be a USB communication interface between the MFP 200 and the outside. Note that in the present embodiment described here, the internal interface is a communication interface using USB, but it may be an internal interface using a different standard. The mainboard 211 and the modem 229 are connected via a dedicated bus 228, for example.

The CPU 212 is a system control unit and controls the entire MFP 200. The processing of the MFP 200 described below is, for example, implemented by the CPU 212 executing a program stored in the ROM 213. Note that dedicated hardware for each process may be prepared. The ROM 213 stores control programs executed by the CPU 212, embedded OS programs, and the like. In the present embodiment, the CPU 212 executes the control programs stored in the ROM 213 under the management of the embedded OS similarly stored in the ROM 213 to perform software control such as scheduling and task switching.

The RAM 214 is constituted by an SRAM or the like. The RAM 214 stores data such as program control variables and the like, setting values registered by the user, management data of the MFP 200, and the like. Also, the RAM 214 may be used as a buffer for various types of work. The non-volatile memory 215 is constituted by memory such as flash memory, for example, and continually stores data even after power to the MFP 200 is turned off. The image memory 216 is constituted by a memory such as a DRAM. The image memory 216 stores image data received via the wireless unit 226, image data processed by the encoding/decoding processing unit 221, and the like. Note that the memory configuration of the MFP 200 is not limited to the configuration described above, and other memory configurations may be used.

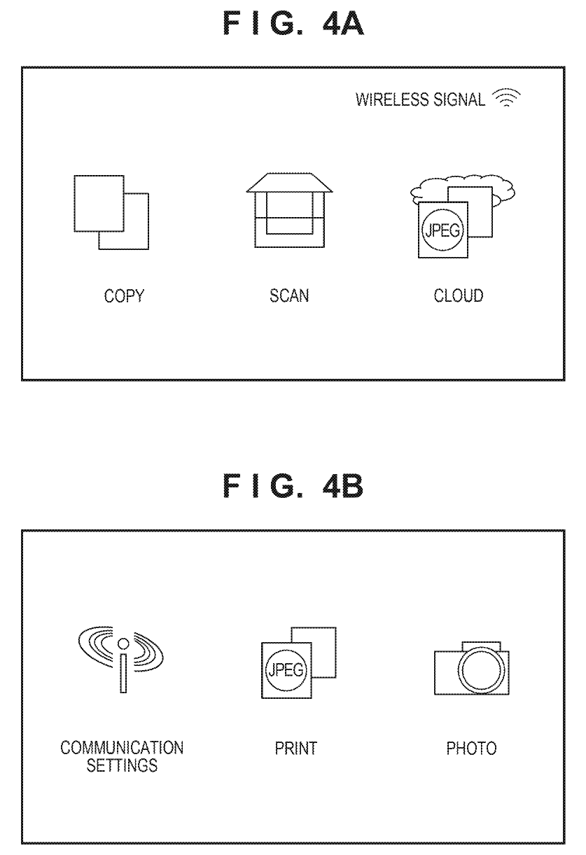

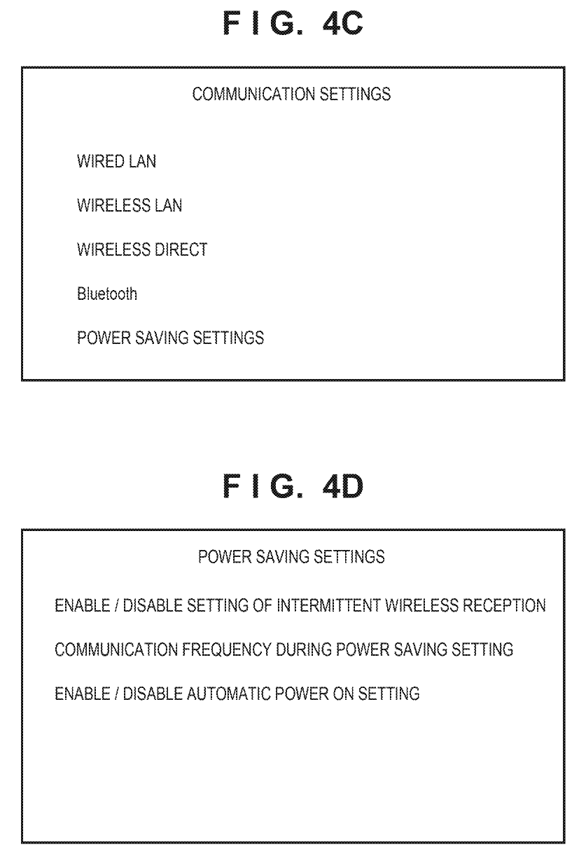

The data conversion unit 218 analyzes data of various formats, converts image data into print data, and the like. The reading control unit 217 controls the reading unit 219 (for example, a contact image sensor (CIS)) to optically read the document placed on the platen 201. The reading control unit 217 converts the image obtained by optically reading the document into electrical image data (an image signal) for output. The reading control unit 217 may perform various types of processing such as binarization processing and halftone processing at this time and then output the image data. The operation display unit 205, for example, displays the user interfaces of FIGS. 4A to 4D and executes display control and electrical signal generation control in accordance with user operations.

The power operation unit 207 may be a factor in determining to display/hide a screen on the operation display unit 205 as well as supplying/stopping the supply of power and the clock signal to unused hardware in response to a user operation. The encoding/decoding processing unit 221 performs encoding processing and decoding processing and enlargement and reduction processing of image data (JPEG, PNG, and the like) handled by the MFP 200. The sheet feeding unit 223 holds sheets for printing. The sheet feeding unit 223 can internally supply sheets that have been set, under the control of the print control unit 224. The sheet feeding unit 223 may include a plurality of sheet feeding units for holding a plurality of types of sheets in one apparatus and can control which sheet feeding unit to feed from under the control of the print control unit 224. The print control unit 224 executes various types of image processing such as smoothing processing, print density correction processing, and color correction on the image data to be printed and outputs the post-processing image data to the printing unit 222. The printing unit 222 is configured to be able to execute an inkjet printing process by discharging ink supplied from ink tanks from a print head and printing an image on a printing medium such as a sheet. Note that the printing unit 222 may be configured to be able to execute another printing process method such as the electro-photographic method. Also, the print control unit 224 may periodically read out information of the printing unit 222 and update status information such as ink remaining amount in the ink tank, print head state, and the like stored in the RAM 214.

The wireless unit 226 is a unit that can provide a WLAN and BT communication function. In other words, the wireless unit 226, following a WLAN or BT protocol, converts data into packets and transmits the packets to an external apparatus or restores packets from an external apparatus into the original data and outputs the data to the CPU 212. The wireless unit 226 can communicate as a station compliant with the IEEE 802.11 standard series. Note that the terminal apparatus 100 and the MFP 200 can perform P2P (WLAN) communication based on WFD, and the wireless unit 226 has a software access point (SoftAP) function or a group owner function. In other words, the wireless unit 226 can form a network using communication in the P2P connection mode, determine a channel to use in communication in the P2P connection mode, and the like.

FIGS. 4A to 4D are diagrams schematically illustrating examples of screen displays of the operation display unit 205 of the MFP 200. FIG. 4A is an example of a home screen displayed while the power of the MFP 200 is turned on and no operations such as printing or scanning are being performed (idle state, standby state). When a menu display of copy, scan, or cloud function using internet communication is selected via a key operation or a touch panel operation, the MFP 200 may start executing the corresponding setting or function. Here, for example, the wireless signal strength is displayed as an icon. Also, the icon display of the wireless signal strength may change in accordance with the state of the infrastructure connection mode. The MFP 200 can seamlessly display a screen different from that of FIG. 4A when a key operation or a touch panel operation on the home screen of FIG. 4A is received. FIG. 4B illustrates such an example and illustrates an example in which a menu including items for executing a print function or photo function, changing communication settings, and the like is displayed. The print function or photo function and communication settings may be executed in response to a user selection on the screen.

FIG. 4C is a diagram illustrating an example of a communication settings screen displayed in a case where “Communication settings” is selected on the screen of FIG. 4B. On the communication settings screen, various types of LAN settings menus (“Wired LAN”, “Wireless LAN”, “Wireless direct”) including a wired connection setting, an infrastructure connection mode enable/disable setting, a WFD or SoftAP mode or similar P2P connection mode enable/disable setting, and the like are displayed in a selectable manner. Note that, in FIG. 4C, in a case where wireless LAN has been set to enabled by a user operation, the infrastructure connection mode becomes enabled, and in a case where wireless direct has been set to enabled by a user operation, the P2P (WLAN) connection mode becomes enabled. On the communication settings screen, a settings menu for BT settings including a BT enable/disable setting and the like indicated by “Bluetooth” is displayed in a selectable manner.

FIG. 4D is an example of a power saving settings screen displayed in a case where “Power saving settings” is selected on the screen of FIG. 4C. The screen of FIG. 4D will be described below.

### Direct Connection Method

Direct connection refers to two apparatuses wirelessly connecting to one another directly (in other words, peer-to-peer) without an external apparatus such as an access point. Direct connection may also be referred to as peer-to-peer connection (P2P connection). The MFP 200 can operate in a mode (P2P connection mode, direct connection mode) for communicating by direct connection, which is one example of a connection mode. In Wi-Fi communication, direct connection modes for communicating via direct connection include a plurality of modes such as a software AP (SoftAP) mode, a Wi-Fi Direct (WFD) mode, and the like.

A mode in which direct connection is executed via WFD is referred to as a WFD mode. WFD is a standard established by the Wi-Fi Alliance and is included in the IEEE 802.11 series communication standards. In the WFD mode, after a communication partner device is searched for via a device search command, the roles of the P2P group owner (GO) and the P2P client are determined, before the remaining wireless connection processing is executed. The group owner corresponds to the Wi-Fi master station (master unit), and the client corresponds to the Wi-Fi slave station (slave device). The role determination corresponds to GO negotiation in P2P, for example. Note that in the WFD mode in a state before role determination has been performed, the MFP 200 is in a state in which it is neither a master station nor a slave station. Specifically, between devices to communicate, first one device issues a device search command and searches for a device to connect to via the WFD mode. When another device corresponding to the communication partner is found, between the devices, information relating to services and functions that each can provide is confirmed. Note that the device-provided information confirmation is optional and not required. The device-provided information confirmation phase corresponds to P2P provision discovery, for example.

Next, the device-provided information is mutually confirmed, and they determine which is to be the P2P client and which is to be the P2P group owner. When the client and the group owner have been determined, the devices exchange parameters for communicating via WFD. On the basis of the exchanged parameters, the remaining P2P wireless connection processing between the client and the group owner and IP connection processing are executed. Note that in the WFD mode, the MFP 200 may always operate as the GO without executing the GO negotiation described above. In other words, the MFP 200 may operate in a WFD mode which is an autonomous GO mode. For example, a state in which the MFP 200 is operating in the WFD mode, in other words, corresponds to a state in which a connection via WFD has not been established but the MFP 200 is operating as the GO or a state in which a connection via WFD has been established and the MFP 200 is operating as the GO.

In the software AP mode, of the devices communicating (for example, the terminal apparatus 100 and the MFP 200), one of the devices (for example, the terminal apparatus 100) takes the role of the client that requests various types of services. Also, the other device implements the function of the AP in Wi-Fi via the software settings. The software AP corresponds to the Wi-Fi master station, and the client corresponds to the Wi-Fi slave station. In the software AP mode, the client searches for a device to be the software AP via a device search command. When a software AP is found, the remaining wireless connection processing (wireless connection establishment and the like) between the client and the software AP is executed, and thereafter, IP connection processing (IP address allocation and the like) is executed. Note that the commands and parameters transmitted and received when establishing a wireless connection between the client and the software AP are as specified in Wi-Fi standards, and thus description thereof will be omitted.

In the present embodiment, in a case where the MFP 200 establishes and maintains a direct connection, the MFP 200 operates as the master station in the network that the MFP 200 belongs to. Note that a master station is an apparatus that forms a wireless network and an apparatus that provides a parameter used in connecting to the wireless network to the slave station. A parameter used in connecting to the wireless network is a parameter relating to a channel used by the master station, for example. The slave station receives the parameter and uses the channel used by the master station to connect to the wireless network formed by the master station. In the direct connection mode, since the MFP 200 operates as the master station, the MFP 200 can determine which frequency band to use in communication in the direct connection mode and which channel to use. In the present embodiment, the MFP 200 can use a channel corresponding to the 2.4 GHz frequency band and a channel corresponding to the 5 GHz frequency band in communication in the direct connection mode.

### Infrastructure Connection Method

Infrastructure connection is a connection method in which an AP (for example, the AP 300), which is for controlling a network of devices (for example, the terminal apparatus 100 and the MFP 200) that will communicate, is connected to and in which the devices communicate via the AP. The MFP 200 can operate in a mode (infrastructure connection mode) for communicating via an infrastructure connection, which is one example of a connection mode.

In an infrastructure connection, each device searches for an AP via a device search command. When an AP is found, the remaining wireless connection processing (wireless connection establishment and the like) between the devices and the AP is executed, and thereafter, IP connection processing (IP address allocation and the like) is executed. Note that the commands and parameters transmitted and received when establishing a wireless connection between the devices and the AP are as specified in Wi-Fi standards, and thus description thereof will be omitted.

In the present embodiment, when the MFP 200 operates via an infrastructure connection, the AP 300 operates as the master station and the MFP 200 operates as the slave station. In other words, in the present embodiment, infrastructure connection refers to a connection between the MFP 200 operating as the slave station and the AP 300 operating as the master station. In a case where the MFP 200 establishes an infrastructure connection and the terminal apparatus 100 also establishes an infrastructure connection with the AP 300, communication between the MFP 200 and the terminal apparatus 100 via the AP 300 can be performed. The channel to use in communication via an infrastructure connection is determined by the AP 300, and the MFP 200 executes communication via an infrastructure connection using the channel determined by the AP 300. In the present embodiment, the MFP 200 can use a channel corresponding to the 2.4 GHz frequency band and a channel corresponding to the 5 GHz frequency band in communication via an infrastructure connection. Note that the MFP 200 can also use, in the communication via the infrastructure connection, a channel corresponding to a DFS band within the 5 GHz frequency band. Note that to communicate with the MFP 200 via the AP 300, the terminal apparatus 100 recognizes and identifies that the MFP 200 belongs on the network that is formed by the AP 300 and that the terminal apparatus 100 belongs to.

In the present embodiment, the MFP 200 includes a power saving state (power saving mode) in which the MFP 200 operates with lower power consumption than when in the normal power state (normal mode). In the power saving state, the power consumption is reduced compared to the normal state of operating. For example, a power saving state refers to a state in which fewer blocks are supplied with power than during the normal state of operating. For example, if a state in which all of the blocks in the MFP 200 of FIG. 3 are being supplied with power is the normal state of operating, the power saving state refers to a state in which the supply of power is stopped for a portion of the blocks. In the present embodiment, the block(s) to which power supply is stopped includes at least the USB host 225. Also, the power saving state according to the present embodiment refers to a state of operating in which the operating clock frequency is lower than during the normal state of operating. A state in which the operating clock frequency is lower than during the normal state of operating is achieved by reducing the operating clock frequency of the CPU 212 installed in the MFP 200. Also, in a case where a plurality of CPUs including a main CPU with a high operating clock frequency, a sub-CPU with a low operating clock frequency, and the like are installed in the MFP 200, reduction of the operating clock frequency may be achieved by switching from the main CPU to the sub-CPU with a lower operating clock frequency.

In the present embodiment, the following condition for transitioning from the normal state to the power saving state is defined as transition condition A. The MFP 200, in the normal state, transitions to the power saving state based on the transition condition A being satisfied. In the present embodiment, in the power saving state, the supply of a clock signal to at least the USB host 225 is stopped or the operating clock frequency is reduced.

Transition condition A: A certain amount of time has passed in a state without a user operation on the MFP 200 after a screen was displayed on the operation display unit 205 of the MFP 200 in response to the user pressing the power operation unit 207.

The MFP 200 monitors the wireless communication state with an external device such as the AP 300 and the like. By monitoring the wireless communication state, the MFP 200 can confirm the connection with an external device, can identify usable channels, and the like. The MFP 200 performs monitoring of the wireless communication state by periodically receiving predetermined wireless information from an external device.

In the present embodiment, the CPU 212 obtains the wireless information received from the AP 300 from the wireless unit 226 via the USB host 225. The wireless information is, for example, information including information indicating the channel used by the AP 300. Also, the wireless information is, for example, information including information for identifying the received signal strength indicator of the wireless information received from the AP 300, information for identifying the signal-to-noise ratio of the wireless information received from the AP 300, and similar information relating to the quality of the communication between the AP 300 and the MFP 200. The CPU 212, for example, can change the display of the wireless signal strength icon illustrated in FIG. 4A based on the value of the received signal strength indicator and the signal-to-noise ratio included in the obtained wireless information. In this manner, the CPU 212 can periodically update the display of the icon based on the wireless information periodically received while in the normal state. Also, the CPU 212 can periodically identify the channel used by the AP 300 by periodically obtaining the wireless information even while in the power saving state with the operation display unit 205 turned off (not displayed). Note that the channel used by the AP 300 corresponds to the channel of the infrastructure connection mode. The channel of the infrastructure connection mode is the channel used by the MFP 200 for connection and communication with the AP 300 via the infrastructure connection mode, for searching for the AP 300, and the like. Thus, for example, processing can be executed to, for example, make the channel used in the P2P connection mode and the channel used in the infrastructure connection mode match or not by periodically identifying the channel of the infrastructure connection mode. Note that the channel of the P2P connection mode is a channel used by the MFP 200 for connection and communication with the terminal apparatus 100 via the P2P connection mode, for transmitting a beacon via a SoftAP function or group owner function, and the like. Also, in the present embodiment, control is performed to make the channel used in the P2P connection mode and the channel used in the infrastructure connection mode not match by identifying the channel used by the AP 300. However, no such limitation is intended, and control may be performed to make the channel used in the P2P connection mode and the channel used in the infrastructure connection mode match by identifying the channel used by the AP 300. Making the channels match is performed, for example, with the goal of improving throughput by making channel switching unnecessary in a case where communication via the infrastructure connection mode and communication via the P2P connection mode occur at the same time with a single antenna. Making the channels not match is performed, for example, with the goal of improving throughput by making channel switching unnecessary in a case where communication via the infrastructure connection mode and communication via the P2P connection mode occur at the same time with a plurality of antennas.

In this manner, the MFP 200 performs periodic reception of wireless information from the AP 300 in both the normal state and the power saving state. In the present embodiment, this periodic reception of wireless information is referred to as “intermittent wireless reception”.

In the present embodiment, specifically, as the intermittent wireless reception processing, the CPU 212 first notifies the USB host 225 with a request for the wireless information. The USB host 225 that received the notification notifies the wireless unit 226 and causes a packet requesting the wireless information to be transmitted from the wireless unit 226 to the AP 300. When the packet is received, the AP 300 transmits the wireless information to the wireless unit 226. Thereafter, the wireless unit 226 transmits the wireless information to the USB host 225. Then, the CPU 212 obtains the wireless information from the USB host 225. In the case of performing intermittent wireless reception, the wireless information is periodically obtained from the USB host 225 by the CPU 212.

The CPU 212, in the power saving state, controls the clock signal supplied to the USB host 225. Control of the clock signal corresponds to, for example, supplying or stopping the supply of the clock signal to the USB host 225. Alternatively, it may refer to increasing or decreasing the operating clock frequency. Specifically, the CPU 212 executes processing for stopping supply of the clock signal to the USB host 225 based on a condition for transitioning to the power saving state being satisfied. Processing for stopping supply of the clock signal to the USB host 225 corresponds to processing known as USB Suspend and processing for transmitting a command for stopping supply of the clock signal to the USB host 225 to the USB host 225. Note that the present processing may be processing for decreasing the operating clock frequency. Also, as the intermittent wireless reception processing executed during the power saving state based on a condition for the intermittent wireless reception processing being satisfied, the CPU 212 executes processing for supplying (resuming supply of) the clock signal to the USB host 225 before notifying (transmitting a command to) the USB host 225 with a request for the wireless information. The condition for the intermittent wireless reception processing is a predetermined amount of time passing from when the intermittent wireless reception processing was last executed. In other words, the condition for the intermittent wireless reception processing is the elapsed time from when the intermittent wireless reception processing was last executed being greater than a threshold. Processing for supplying the clock signal to the USB host 225 corresponds to processing known as USB Resume and processing for transmitting a command for supplying the clock signal to the USB host 225 to the USB host 225. By supply of the clock signal to the USB host 225 being resumed, the USB host 225 can receive the notification of a request for the wireless information from the CPU 212 and notify the wireless unit 226, can receive the wireless information from the wireless unit 226 and transfer the wireless information to the CPU 212, and the like. Note that the present processing may be processing for increasing the operating clock frequency. Thereafter, when the CPU 212 receives the wireless information from the USB host 225, the CPU 212 again executes the processing for stopping supply of the clock signal to the USB host 225. Via this processing, with the MFP 200 operating in the power saving state, the USB host 225 can reduce the power consumption by receiving supply of the clock signal only in a case where processing executed by the USB host 225 is necessary and not receiving supply of the clock signal in other cases. Also, in a case where the channel used by the AP 300 is changed, the AP 300 notifies the wireless unit 226 that the channel used by the AP 300 has changed. Thereafter, in a case where supply of the clock signal to the USB host 225 is not being performed, the wireless unit 226 or the CPU 212 executes processing for supplying the clock signal to the USB host 225. Then, the wireless unit 226 notifies the USB host 225 that the channel used by the AP 300 has changed. The wireless unit 226 executes processing to search for the AP 300 that had the channel that it uses changed using all of the channels that the wireless unit 226 can use and, in a case where the AP 300 is found via this search, transmits information indicating the channel used by the AP 300 to the USB host 225. Then, the USB host 225 transmits this information to the CPU 212. Thereafter, the wireless unit 226 or the CPU 212 executes processing for stopping supply of the clock signal to the USB host 225.

As described above, in both the normal state and the power saving state of the MFP 200, intermittent wireless reception is performed, and the CPU 212 obtains the wireless information. However, for example, in a case where supply of the clock signal to the USB host 225 has been stopped in the power saving state, if the clock signal is supplied to the USB host 225 in order to perform intermittent wireless reception, the power saving effect is reduced. Also, in a case where the operating clock frequency has been decreased in the power saving state, if the operating clock frequency is increased in order to perform intermittent wireless reception, the power saving effect is reduced.

Regarding this, in the present embodiment, in the power saving state, the frequency at which the wireless information is obtained is decreased. In other words, in the power saving state, the interval between when the wireless information is obtained is increased. This allows a reduction in the power saving effect to be suppressed.

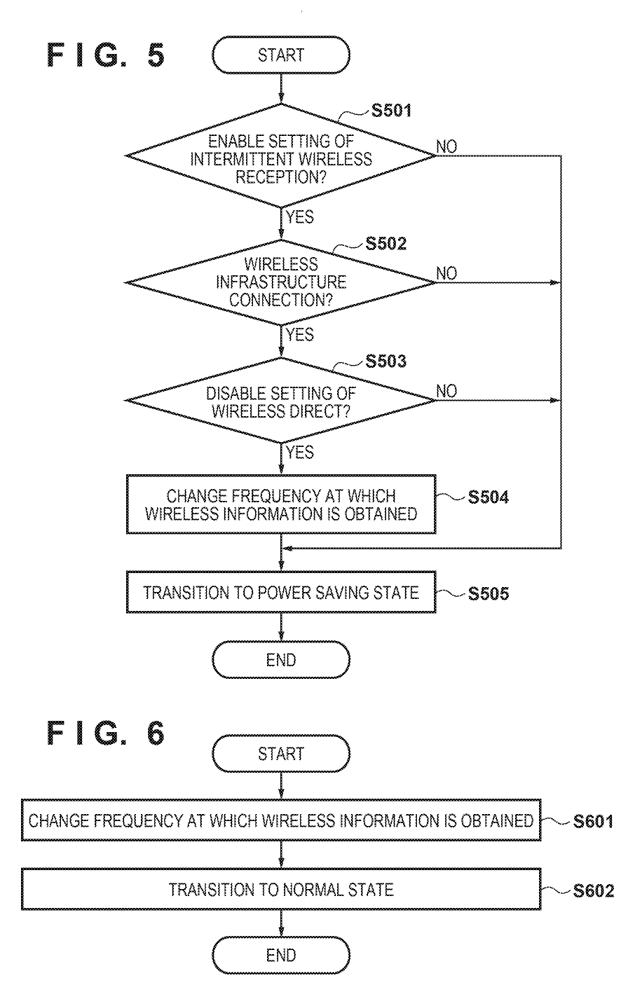

FIG. 5 is a flowchart illustrating processing when the MFP 200 transitions from the normal state to the power saving state. The processing in FIG. 5 is implemented by the CPU 212 reading out a program stored in the ROM 213 into the RAM 214 and executing the program, for example. Also, the processing of FIG. 5 is started in a case where the transition condition A described above is satisfied.

In S501, the CPU 212 determines whether or not control of intermittent wireless reception is enabled. The determination of S501, for example, is performed based on the settings content of the power saving settings screen of FIG. 4D.

The power saving settings screen of FIG. 4D will now be described. The power saving settings screen of FIG. 4D is displayed in a case where “Power saving settings” is selected on the screen of FIG. 4C. The power saving settings screen includes an item for setting control of intermittent wireless reception to enabled or disabled. The user can set control of intermittent wireless reception to enabled or disabled on the power saving settings screen. By control of intermittent wireless reception being set to disabled, even in the power saving state, the wireless information is obtained at a frequency similar to that of the normal state. In other words, even in the power saving state, the interval between when the wireless information is obtained is similar to that of the normal state. On the other hand, by control of intermittent wireless reception being set to enabled, in the power saving state, the wireless information is obtained at a lower frequency compared to the normal state. In other words, in the power saving state, the interval between when the wireless information is obtained is longer compared to the normal state. Also, the interval controlled according to the present embodiment is, specifically, the interval from the time the condition for the intermittent wireless reception processing was last satisfied to the time the condition for the intermittent wireless reception processing is next satisfied. In other words, it is a threshold for determining whether or not the condition for the intermittent wireless reception processing has been satisfied. As a result, the interval controlled according to the present embodiment corresponds to the interval between the processing for notifying the USB host 225 of a request for the wireless information in the n-th intermittent wireless reception and the processing for notifying the USB host 225 of a request for the wireless information in the n+1-th intermittent wireless reception. Alternatively, the interval corresponds to the interval from the processing for supplying the clock signal to the USB host 225 in the n-th intermittent wireless reception to the processing for supplying the clock signal to the USB host 225 in the n+1-th intermittent wireless reception. Also, the CPU 212 may be an assembly of a plurality of processors configured by a main system and a sub-system. Also, in a case where the main system determines whether or not the condition for the intermittent wireless reception processing is satisfied using the threshold and the condition is determined to be satisfied, a notification requesting the wireless information may be performed from the main system to the sub-system. In a case where the sub-system is notified with a request for the wireless information, a notification requesting the wireless information may be performed from the sub-system to the USB host 225. The interval control in this manner corresponds to the threshold used by the main system in the determination. Also, the interval corresponds to the interval from when a notification requesting the wireless information is performed from the main system to the sub-system in the n-th intermittent wireless reception to when a notification requesting the wireless information is performed from the main system to the sub-system in the n+1-th intermittent wireless reception.

In a case where it is determined that control of intermittent wireless reception is enabled, the processing advances to S502. In a case where it is determined that control of intermittent wireless reception is not enabled, the processing advances to S505, and a change of the frequency at which the wireless information is obtained is not performed in S504 described below. In other words, S501 can be considered processing for determining whether or not to change the frequency at which the wireless information is obtained. Furthermore, S501 can be considered processing for determining whether or not to change the interval at which the wireless information is obtained.

In S502, the CPU 212 determines whether or not the MFP 200 is in a state with an infrastructure connection with the AP 300. The determination of S502, for example, is performed based on the settings content of the communication settings screen of FIG. 4C. In a case where it is determined that the MFP 200 is in a state with an infrastructure connection, the processing advances to S503. In a case where it is determined that the MFP 200 is not in a state with an infrastructure connection, the processing advances to S505, and a change of the frequency at which the wireless information is obtained is not performed in S504 described below. In other words, S502 can be considered processing for determining whether or not to change the frequency at which the wireless information is obtained. Furthermore, S502 can be considered processing for determining whether or not to change the interval at which the wireless information is obtained.

For example, in a case where infrastructure connection is set to enabled and an infrastructure connection is established between the MFP 200 and the AP 300, the processing advances to S503. As an operation of the MFP 200 according to the present embodiment, in a case where the MFP 200 is not in a state with an infrastructure connection, it can be expected that the amount of information that the MFP 200 receives from the AP 300 will be small. Thus, in a case where the MFP 200 is not in a state with an infrastructure connection, it can be expected that the wireless information is not periodically received in either the normal state or the power saving state. Accordingly, in a case where the MFP 200 is not in a state with an infrastructure connection, control is performed in such a manner that the processing of S504 described below is not executed.

In S503, the CPU 212 determines whether or not wireless direct is set to disabled. The determination of S503, for example, is performed based on the settings content of the communication settings screen of FIG. 4C. Wireless direct being set to disabled refers to, for example, a state in which the P2P connection mode is not activated. In a case where it is determined that wireless direct is set to disabled, the processing advances to S504. In a case where it is determined that wireless direct is not set to disabled, the processing advances to S505, and a change of the frequency at which the wireless information is obtained is not performed in S504 described below. In other words, S503 can be considered processing for determining whether or not to change the frequency at which the wireless information is obtained. Furthermore, S503 can be considered processing for determining whether or not to change the interval at which the wireless information is obtained.

In S504, the CPU 212 changes the frequency at which the wireless information is obtained. In other words, the CPU 212 sets the interval at which the wireless information is obtained in the power saving state before transitioning the MFP 200 to the power saving state. In S504, the CPU 212 decreases the frequency at which the wireless information is obtained to less than that of the normal state. Specifically, for example, if the interval at which the wireless information is obtained in the normal state is 5 seconds, the CPU 212 changes the interval in the power saving state to 30 seconds. In other words, the CPU 212 changes the threshold used to determine whether or not the condition for the intermittent wireless reception processing has been satisfied from 5 seconds to 30 seconds. Note that the interval is not limited to 30 seconds and it is sufficient that it is longer than when in the normal state. Also, for example, control may be performed in such a manner that the processing to periodically obtain the wireless information is stopped by setting the seconds to infinity or the like.

Here, the effect of executing the processing of S504 in a case where wireless direct is set to disabled will be described. By the channel used in the infrastructure connection mode being periodically identified, processing including making the channel used in the P2P connection mode and the channel used in the infrastructure connection mode match or not match can be executed. Thus, in a case where wireless direct is set to disabled, there is little need to execute processing to identify the channel of the infrastructure connection mode, and thus even if control is performed to decrease the frequency at which the wireless information is obtained, the effect of this would be minimal. In other words, in a case where wireless direct is set to disabled, by decreasing the frequency at which the wireless information is obtained, a reduction in the power saving effect can be suppressed.

In S505, the CPU 212 transitions the state of the MFP 200 to the power saving state, and thereafter ends the processing of FIG. 5. In S505, for example, the CPU 212 performs control to stop the supply of power to a portion of the blocks in the MFP 200. Also, for example, the CPU 212 performs control to decrease the operating clock frequency. The determination methods of S501, S502, and S503 are examples, and other determination methods may be used. For example, in S503, in a case where wireless direct is set to enabled, the frequency at which the wireless information is obtained may be changed. Also, at times other than when communication via the infrastructure connection mode and communication via the direct connection mode are simultaneously in operation, the frequency at which the wireless information is obtained may be changed, and the power saving effect may be improved.

FIG. 6 is a flowchart illustrating processing when the MFP 200 transitions from the power saving state to the normal state. The processing in FIG. 6 is implemented by the CPU 212 reading out a program stored in the ROM 213 into the RAM 214 and executing the program, for example. The processing of FIG. 6 is started in a case where a condition for transitioning from the power saving state to the normal state is satisfied. This condition is, for example, a key operation on the operation display unit 205 by a user, a press of the power operation unit 207, reception of print data from an external apparatus, or the like.

In S601, the CPU 212 changes the frequency at which the wireless information is obtained to an obtainment frequency corresponding to the normal state. In other words, the CPU 212 sets the interval at which the wireless information is obtained in the normal state before transitioning the MFP 200 to the normal state. Specifically, for example, in a case where this is set to 5 seconds for the normal state and 30 seconds for the power saving state, in S601, the interval at which the wireless information is obtained is changed from 30 seconds to 5 seconds. Also, in a case where processing to periodically obtain the wireless information is stopped, processing to periodically obtain the wireless information may be resumed.

In S602, the CPU 212 transitions the state of the MFP 200 to the normal state, and thereafter ends the processing of FIG. 6. In S602, for example, the CPU 212 performs control to resume the supply of power to the block(s) that had their power supply stopped in the MFP 200. Also, for example, the CPU 212 performs control to increase the operating clock frequency.

The processing is not limited to the processing of FIG. 6, and other processing may be executed. For example, the processing of S601 and the processing of S602 may be executed in the reverse order. In other words, the frequency at which the wireless information is obtained may be changed just after the transition from the power saving state to the normal state.

FIG. 7 is a flowchart illustrating the processing for obtaining the wireless information. The processing in FIG. 7 is implemented by the CPU 212 reading out a program stored in the ROM 213 into the RAM 214 and executing the program, for example. The processing of FIG. 7 is executed at regular intervals while the MFP 200 is activated. A case where the wireless information is obtained at a 5 second interval in the normal state and obtained at a 30 second interval in the power saving state will be described below as an example. In this case, the processing of FIG. 7 is executed once every 5 seconds regardless of whether it is the normal state or the power saving state.

In S701, the CPU 212 determines whether or not the currently set frequency at which the wireless information is obtained is the obtainment frequency corresponding to the normal state. Specifically, for example, it is determined whether or not the currently set interval at which the wireless information is obtained is 5 seconds. For example, in a case where the interval at which the wireless information is obtained has been changed to 30 seconds in S504, it is determined that the obtainment frequency is not the obtainment frequency corresponding to the normal state. In a case where it is determined that the obtainment frequency is the obtainment frequency corresponding to the normal state, the processing advances to S704. In a case where it is determined that the obtainment frequency is not the obtainment frequency corresponding to the normal state, the processing advances to S702.

In S704, the CPU 212 sets the number of skips to zero. Here, skip refers to not executing the processing to obtain the wireless information at the timing of when the obtainment processing is supposed to be executed. Specifically, for example, to make the 5 seconds for the interval at which the wireless information is obtained 30 seconds, the processing to obtain the wireless information performed every 5 seconds can be skipped 5 times in a row to make the interval at which the wireless information is obtained 30 seconds. The number of skips refers to the number of skips as described above. In a case where it is determined that the obtainment frequency is the obtainment frequency corresponding to the normal state in S701, there is no need to perform a skip, and thus the number of skips in S704 is set to zero.

In S705, the CPU 212 transmits, to the USB host 225, a command to the USB host 225 requesting the wireless information to be obtained. In a case where the state is the power saving state, in addition to the command requesting the wireless information to be obtained, transmission of a command for resuming supply of the clock signal, increasing the operating clock frequency, or the like is performed. By transmitting a command requesting the wireless information to be obtained to the USB host 225, the CPU 212, thereafter, can obtain the wireless information included in the packet received from the AP 300 via the USB host 225. In a case where the state is the power saving state, when the CPU 212 obtains the wireless information, the CPU 212 transmits a command for stopping supply of the clock signal, decreasing the operating clock frequency, or the like to the USB host 225.

In a case where it is determined that the currently set frequency at which the wireless information is obtained is not the obtainment frequency corresponding to the normal state in S701, in S702, the CPU 212 determines whether or not the number of skips is the maximum value. For example, in a case where the interval corresponding to the normal state is 5 seconds and the interval corresponding to the power saving state is 30 seconds, the maximum value for the number of skips is 5 (30 seconds/5 seconds - 1). In a case where it is determined that the number of skips is not the maximum value, in S703, the CPU 212 increments the number of skips by +1. In a case where it is determined that the number of skips is the maximum value, in S704, the CPU 212 sets the number of skips to zero. Thereafter, in S705, the CPU 212 transmits, to the USB host 225, a command to the USB host 225 requesting the wireless information to be obtained.

In the present embodiment, the processing for skipping the wireless information obtainment processing by repeating the flowchart illustrated in FIG. 7 at regular intervals has been described. However, it is sufficient that processing for managing the regular interval (for example, 5 seconds) and processing that can change the regular interval to a longer amount of time (for example, 30 seconds) when in the power saving state are provided, and a flowchart other than that of FIG. 7 may be used.

As described above, in the present embodiment, the frequency at which the wireless information is obtained in the power saving state is changed to an obtainment frequency that is less than when in the normal state. This allows a reduction in the power saving effect to be suppressed. Note that in the present embodiment, when the MFP 200 transitions to the power saving state, the MFP 200 executes intermittent wireless reception in the power saving state regardless of whether or not it is operating in the P2P connection mode. However, no such limitation is intended. As described above, in the present embodiment, control is performed in such a manner that, by periodically identifying the channel of the infrastructure connection mode via intermittent wireless reception, the channel used in the P2P connection mode and the channel used in the infrastructure connection mode are made not to match. In other words, intermittent wireless reception can be considered processing that is effective when the MFP 200 is operating in the P2P connection mode. Accordingly, the MFP 200, for example, may determine whether or not the MFP 200 is operating in the P2P connection mode when the condition for transitioning to the power saving state is satisfied. Also, in a case where it is determined that the MFP 200 is operating in the P2P connection mode, in the power saving state, the MFP 200 may execute intermittent wireless reception after increasing the length of the interval at which the wireless information is obtained. Also, in a case where it is determined that the MFP 200 is not operating in the P2P connection mode, in the power saving state, the MFP 200 may perform control to not execute intermittent wireless reception. Note that the MFP 200 performs control to stop the supply of power to the operation display unit 205 and does not perform a display by the operation display unit 205, and thus a display of the wireless signal strength icon illustrated in FIG. 4A is also not performed.

### Second Embodiment

The differences between the second embodiment and the first embodiment will be described below. In the present embodiment, three types of power saving states are supposed. In the present embodiment, the MFP 200 includes a power saving state 1, a power saving state 2, and a power saving state 3. The power saving state 1 corresponds to the power saving state according to the first embodiment. The power saving state 2 is a state in which the power consumption is reduced more than in the power saving state 1. The power saving state 3is a state in which the power consumption is reduced more than in the power saving state 2.

The power saving state 1, the power saving state 2, and the power saving state 3 and the respective supply of power to the printing unit 222 will now be described. In the normal state, power is supplied to all of the power supply target sites included in the printing unit 222. In contrast, the power saving state 1 is a state in which power is supplied to a portion of the power supply target sites included in the printing unit 222 and power is not supplied to a portion. Also, the power saving state 1 is a state of operating with the operating clock frequency at a lower state than at the time of normal state operations.

The power saving state 2 is a state in which power is not supplied to any of the power supply target sites included in the printing unit 222. The blocks that are not supplied with power in the power saving state 1 other than the printing unit 222 are also not supplied with power in the power saving state 2. Also, in the power saving state 2, there are blocks that are not supplied with power that are not blocks not supplied with power in the power saving state 1. Also, the power saving state 2 is a state of operating with the operating clock frequency at a lower state than at the time of operations in the power saving state 1.

Power saving state 3 is a state in which the main program of the MFP 200 is not activated and power is supplied only to the minimum required hardware for detecting a press of the power operation unit 207. Also, the power saving state 3 is a state of operating with the operating clock frequency at a lower state than at the time of operations in the power saving state 2. Note that the power saving state 3 may be referred to as a software power off state.

In the present embodiment, in a case where the power operation unit 207 is pressed, the MFP 200 transitions to the power saving state 2 or the power saving state 3. In other words, in a case where the power operation unit 207 is pressed while in the normal state, the MFP 200 transitions from the normal state to the power saving state 2 or the power saving state 3. Also, in a case where the power operation unit 207 is pressed while in the power saving state 1, the MFP 200 transitions from the power saving state 1 to the power saving state 2 or the power saving state 3. In the present embodiment, a press of the power operation unit 207 for transitioning to the power saving state 2 or the power saving state 3 is referred to as transition condition B.

In the present embodiment, in a case where the transition condition B is satisfied, if an automatic power on setting is enabled, the MFP 200 transitions to the power saving state 2, and if the automatic power on setting is disabled, the MFP 200 transitions to the power saving state 3. In the present embodiment, the automatic power on setting can be set by the user on the settings screen of FIG. 4D.

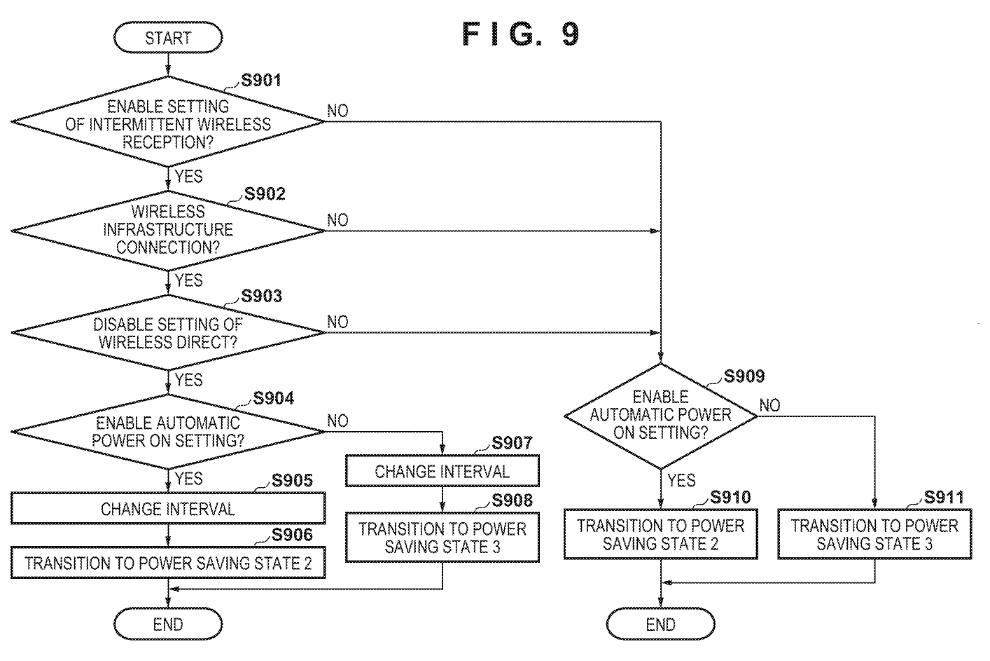

When the item “Enable/Disable automatic power on setting” of FIG. 4D is selected, the user can set the automatic power on setting to enabled or disabled. When the setting is set to enabled and the MFP 200 receives print data from an external apparatus while in the power saving state 2, without operation of the power operation unit 207 by the user, power is supplied to all of the power supply target sites of the printing unit 222, a screen is displayed on the operation display unit 205, and printing is made executable (transition to normal state). On the other hand, in a case where the transition condition B is satisfied and the automatic power on setting is disabled, the MFP 200 transitions to the power saving state 3. The processing in a case where the transition condition B is satisfied will be described below using FIG. 9.

In the present embodiment, as in the first embodiment, in a case where the transition condition A is satisfied in the normal state, the processing of FIG. 5 is executed. As described in the first embodiment, in S504, the interval at which the wireless information is obtained is changed to a predetermined interval. In the present embodiment, the user can set the interval for after the change in S504.

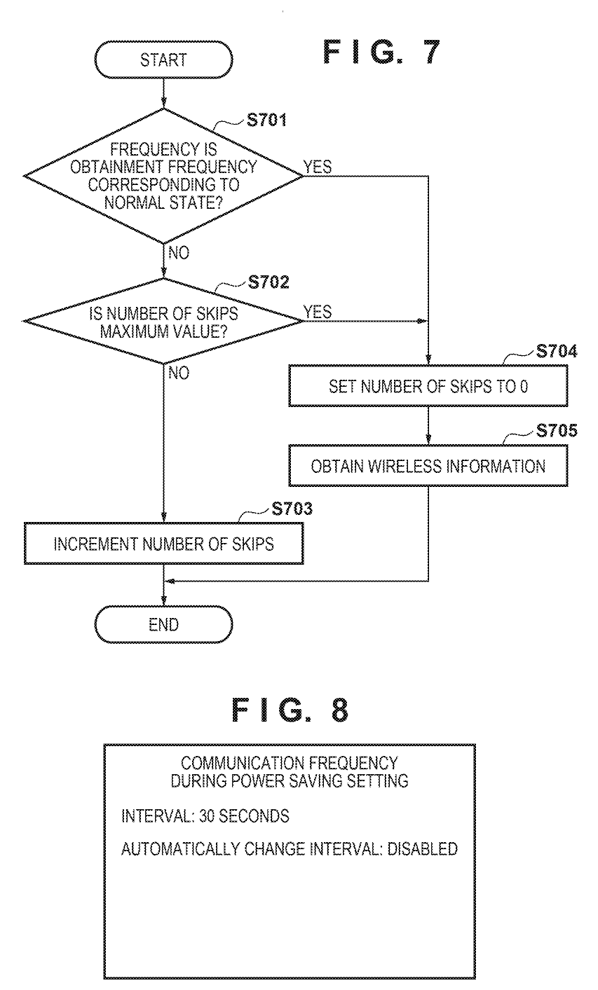

FIG. 8 is a diagram illustrating an example of a screen where the interval at which the wireless information is obtained in the power saving state 1 can be set. The screen of FIG. 8 is displayed in a case where the item “Communication frequency during power saving setting” is selected on the screen of FIG. 4D. On the screen of FIG. 8, the user can input an interval. For example, the user can change the setting value of “30 seconds” for the item “Interval” on the screen of FIG. 8 to a setting value ranging from 1 second to 100 seconds. In S504, the CPU 212 changes the interval at which the wireless information is obtained to the setting value (for example, a setting value ranging from 1 second to 100 seconds) set on the screen of FIG. 8. Via this configuration, in a case where the user wishes to increase the power saving effect, for example, the interval can be set to a higher value.

Also, in the present embodiment, the interval for after the change in S504 (that is, the interval at which the wireless information is obtained in the power saving state 1) can be automatically set without a user operation.

On the screen of FIG. 8, the user can set automatic changing of the interval at which the wireless information is obtained to enabled or disabled. In a case where "Automatically change interval” is set to enabled on the screen of FIG. 8, the CPU 212 automatically sets the interval at which the wireless information is obtained in the power saving state 1 without a user operation. For example, the CPU 212 sets the interval at which the wireless information is obtained in the power saving state 1 based on the received signal strength indicator, the signal-to-noise ratio, and the like included in the wireless information obtained from an external apparatus in the normal state. For example, in a case where the obtained received signal strength indicator is greater than a threshold, it is presumed that the external apparatus is located relatively close to the MFP 200, and thus the CPU 212 sets an interval that is longer than the interval (for example, the 5 seconds described above) in the normal state and shorter than the interval (for example, the 30 seconds described above) set by default as the interval at which the wireless information is obtained in the power saving state 1. Also, for example, the interval at which the wireless information is obtained in the power saving state 1 may be set based on the transmission frequency of a command from an external apparatus to the MFP 200. Here, a command is, for example, a request command relating to information of the received signal strength indicator held by the MFP 200 that is transmitted from an external apparatus such as a PC to the MFP 200. In a case where the transmission frequency (for example, the number of times per unit time) of a command from an external apparatus to the MFP 200 is equal to or greater than a threshold, the CPU 212 sets an interval that is longer than the interval (for example, the 5 seconds described above) in the normal state and shorter than the interval (the 30 seconds described above) set by default as the interval at which the wireless information is obtained in the power saving state 1.

Note that in a case where “Automatically change interval” is set to enabled on the screen of FIG. 8, the item “Interval” is displayed and controlled to be unable to be set. That is, in this case, the user cannot set the interval at which the wireless information is obtained. In other words, priority is given to the set interval without a user operation.

In this manner, in the present embodiment, the interval in the power saving state 1 can be set. Accordingly, the user can adjust the level of the power saving effect in the power saving state 1. Also, the interval in the power saving state 1 can be controlled according to the surrounding environment of the MFP 200 without a user operation.

In the present embodiment, as in the first embodiment, the MFP 200 transitions from the power saving state 1 to the normal state via the processing of FIG. 6. Also, in a case where the condition for transitioning to the normal state is satisfied in the power saving state 2, the MFP 200 transitions to the normal state by executing the processing of FIG. 6. The condition for transitioning to the normal state in this case is, for example, the MFP 200 receiving print data from an external device. Also, in a case where the condition for transitioning to the normal state is satisfied in the power saving state 3, the MFP 200 transitions to the normal state by executing the processing of FIG. 6. The condition for transitioning to the normal state in this case is, for example, a press of the power operation unit 207.

In a case where the transition condition B is satisfied, the MFP 200 executes the flowchart of FIG. 9 and transitions to the power saving state 2 or the power saving state 3.

FIG. 9 is a flowchart illustrating processing when the MFP 200 transitions to the power saving state 2 or the power saving state 3. The processing in FIG. 9 is implemented by the CPU 212 reading out a program stored in the ROM 213 into the RAM 214 and executing the program, for example. Also, the processing of FIG. 9 is started in a case where the transition condition B described above is satisfied while in the normal state or the power saving state 1.

Steps S901 to S903 are the same as steps S501 to S503 and thus will not be described. In a case where it is determined that wireless direct is set to disabled in S903, the processing advances to S904.

In S904, the CPU 212 determines whether or not the automatic power on setting is set to enabled. The determination of S904 is performed based on the setting content of the item “Enable/disable automatic power on setting” of FIG. 4D. In a case where it is determined that the automatic power on setting is set to enabled, in S905, the CPU 212 changes the frequency at which the wireless information is obtained. In this case, the interval is changed to an interval that is longer than the interval for after the change in S504. Specifically, for example, the interval may be changed to an interval that is twice as long as the interval for after the change in S504. Accordingly, in the power saving state 2 in which the power consumption is reduced more than in the power saving state 1, the interval at which the wireless information is obtained can further be made longer than the interval in the power saving state 1. In the present embodiment, in S905, the interval may be made equal to the interval for after the change in S504.

After S905, in S906, the CPU 212 causes the MFP 200 to transition to the power saving state 2 and thereafter ends the processing of FIG. 9. On the other hand, in a case where it is determined that the automatic power on setting is not set to enabled in S904, in S907, the CPU 212 changes the frequency at which the wireless information is obtained. In this case, the interval is changed to an interval that is longer than the interval for after the change in S905. Accordingly, in the power saving state 3 in which the power consumption is reduced more than in the power saving state 2, the interval at which the wireless information is obtained can further be made longer than the interval in the power saving state 2. After S907, in S908, the CPU 212 causes the MFP 200 to transition to the power saving state 3 and thereafter ends the processing of FIG. 9. Note that in the case of a transition to the power saving state 3, intermittent wireless reception processing itself may not be executed. In this case, in a case where it is determined that the automatic power on setting is not set to enabled in S904, the processing of S907 is not executed, and the processing of S908 is executed.

In a case where it is determined that control of intermittent wireless reception is not enabled in S901, and in a case where it is determined that the MFP 200 is not in a state with an infrastructure connection with the AP 300 in S902, and in a case where it is determined that a wireless direct is not set to disabled in S903, the processing advances to S909.

In S909, the CPU 212 determines whether or not the automatic power on setting is set to enabled. The determination of S909 is performed based on the setting content of the item “Enable/disable automatic power on setting” of FIG. 4D. In a case where it is determined that the automatic power on setting is set to enabled, in S910, the CPU 212 causes the MFP 200 to transition to the power saving state 2 and thereafter ends the processing of FIG. 9. On the other hand, in a case where it is determined that the automatic power on setting is not set to enabled in S909, in S911, the CPU 212 causes the MFP 200 to transition to the power saving state 3 and thereafter ends the processing of FIG. 9.

In this manner, in a case where the transition condition B described above is satisfied in the normal state or the power saving state 1 and the condition (S901 to S903) for changing the interval at which the wireless information is obtained is satisfied, the interval is changed when the state transitions to the power saving state 2 or the power saving state 3.

The processing of FIG. 7 according to the present embodiment will now be described. In this example, the interval at which the wireless information is obtained in the normal state is 5 seconds, the interval at which the wireless information is obtained in the power saving state 1 is 30 seconds, and the interval at which the wireless information is obtained in the power saving state 2 is 60 seconds. The maximum value of the number of skips is set based on the interval in the normal state. In the example described above, in a case where the processing advances from S701 to S702 while the MFP 200 is in the power saving state 1, 5 skips (30 seconds/5 seconds - 1) is obtained as the maximum value of the number of skips, and the processing of S702 is executed based on this maximum value. Also, in a case where the processing advances from S701 to S702 while the MFP 200 is in the power saving state 2, 11 skips (60 seconds/5 seconds - 1) is obtained as the maximum value of the number of skips, and the processing of S702 is executed based on this maximum value.

As described above, in the present embodiment, in the power saving state 2 in which the power consumption is reduced more than in the power saving state 1, the frequency at which the wireless information is obtained can be further decreased. This allows a reduction in the power saving effect to be suppressed in the power saving state 2 as well. Also, the frequency at which the wireless information is obtained can be set as appropriate based on a frequency at which the wireless information is obtained set by a user and a frequency at which the wireless information is obtained set without a user operation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-013209, filed January 29, 2025 which is hereby incorporated by reference herein in its entirety.

What is claimed is:

1. An information processing apparatus having a first power state and a second power state in which power consumption is reduced compared to the first power state, comprising:
at least one memory and at least one processor which function as:
an obtaining unit configured to obtain, via a communication interface, from an external device to which the information processing apparatus is connected, predetermined information including information indicating a channel used by the external device, at a regular interval; and
a control unit configured to, in the first power state, control the obtaining unit to obtain the predetermined information from the external device at a first interval, and, in the second power state, in a case where the predetermined information is to be obtained from the external device, perform control to supply power to the communication interface and control the obtaining unit to obtain the predetermined information from the external device at a second interval longer than the first interval.

2. The information processing apparatus according to claim 1, wherein
the external device is an access point, and
when the information processing apparatus transitions from the first power state to the second power state, in a case where the information processing apparatus has an infrastructure connection with the access point, the control unit changes an interval at which the predetermined information is obtained from the external device from the first interval to the second interval.

3. The information processing apparatus according to claim 2, wherein
when the information processing apparatus transitions from the first power state to the second power state, in a case where a setting according to which the information processing apparatus establishes a direct connection with a terminal apparatus without using the access point is disabled, the control unit changes the interval at which the predetermined information is obtained from the external device from the first interval to the second interval.

4. The information processing apparatus according to claim 2, wherein
when the information processing apparatus transitions from the first power state to the second power state, in a case where a setting according to which the information processing apparatus establishes a direct connection with a terminal apparatus without using the access point is enabled, the control unit changes the interval at which the predetermined information is obtained from the external device from the first interval to the second interval.

5. The information processing apparatus according to claim 2, wherein
when the information processing apparatus transitions from the first power state to the second power state, in a case where an intermittent wireless reception function for obtaining the predetermined information from the external device via the communication interface at a regular interval is enabled, the control unit changes the interval at which the predetermined information is obtained from the external device from the first interval to the second interval.

6. The information processing apparatus according to claim 5, wherein
when the information processing apparatus transitions from the first power state to the second power state, in a case where the intermittent wireless reception function is disabled, the control unit controls the obtaining unit to obtain the predetermined information from the external device at the first interval.

7. The information processing apparatus according to claim 2, wherein
the predetermined information further includes information relating to a quality of communication between the information processing apparatus and the external device.

8. The information processing apparatus according to claim 1, wherein
the at least one memory and at least one processor further function as
a setting unit configured to set the second interval.

9. The information processing apparatus according to claim 8, wherein
the setting unit executes at least one from among:
processing for setting an interval input via a user operation as the second interval, processing for setting the second interval based on a frequency of reception of a request to obtain the predetermined information, and processing for setting the second interval based on at least one of a received signal strength indicator and a communication quality of wireless communication between the information processing apparatus and the external device.

10. The information processing apparatus according to claim 1, wherein
the information processing apparatus further has a third power state and a fourth power state in each of which power consumption is lower than in the second power state, and
the information processing apparatus is controlled to transition from the second power state to the third power state or transition from the second power state to the fourth power state, based on a setting relating to power saving.

11. The information processing apparatus according to claim 10, wherein
the fourth power state is a state in which power consumption is lower than in the third power state, and
in a case where a function according to which specific processing is started without a user operation being performed is enabled as the setting relating to power saving, the information processing apparatus is controlled to transition from the second power state to the third power state.

12. The information processing apparatus according to claim 11, wherein
in a case where, the function according to which specific processing is started without a user operation being performed is disabled as the setting relating to power saving, the information processing apparatus is controlled to transition from the second power state to the fourth power state.

13. The information processing apparatus according to claim 10, wherein
in a case where the information processing apparatus transitions from the second power state to the third power state, the control unit changes an interval at which the predetermined information is obtained from the external device from the second interval to a third interval.

14. The information processing apparatus according to claim 13, wherein
the third interval is equal to the second interval or longer than the second interval.

15. The information processing apparatus according to claim 1, wherein
the second power state is a state in which at least supply of a clock signal to the communication interface is stopped.

16. The information processing apparatus according to claim 15, wherein
in the second power state, in a case where the predetermined information is to be obtained from the external device, the control unit starts supply of the clock signal to the communication interface, as control for supplying power to the communication interface.

17. The information processing apparatus according to claim 1, wherein
the second power state is a state in which control is performed to at least decrease a frequency of a clock signal supplied to the communication interface.

18. The information processing apparatus according to claim 17, wherein
in the second power state, in a case where the predetermined information is to be obtained from the external device, the control unit increases a frequency of the clock signal supplied to the communication interface, as control for supplying power to the communication interface.

19. A method executed by an information processing apparatus having a first power state and a second power state in which power consumption is reduced compared to the first power state, comprising:
obtaining, via a communication interface, from an external device to which the information processing apparatus is connected, predetermined information including information indicating a channel used by the external device, at a regular interval;
in the first power state, performing control to obtain the predetermined information from the external device at a first interval; and
in the second power state, in a case where the predetermined information is to be obtained from the external device, performing control to supply power to the communication interface and performing control to obtain the predetermined information from the external device at a second interval longer than the first interval.

20. A non-transitory computer-readable storage medium storing a program configured to cause a computer of an information processing apparatus, which has a first power state and a second power state in which power consumption is reduced compared to the first power state, to function to:
obtain, via a communication interface, from an external device to which the information processing apparatus is connected, predetermined information including information indicating a channel used by the external device, at a regular interval;
in the first power state, perform control to obtain the predetermined information from the external device at a first interval; and
in the second power state, in a case where the predetermined information is to be obtained from the external device, perform control to supply power to the communication interface and perform control to obtain the predetermined information from the external device at a second interval longer than the first interval.
